(19) United States
(12) Patent Application Publication
(10) Pub. No.: US 2005/0015613 A1
(43) Pub. Date: Jan. 20, 2005

(54) Wireless identification lock

(76) Inventor: Zyh-Ming Huang, Taipei Hsien (TW)

Correspondence Address: HUNG ZYH-MING, 235 Chung-Ho, P.O. BOX 10-69, Taipei, TW

(21) Appl. No.: 10/618,218

(22) Filed: Jul. 14, 2003

(51) Int. Cl. H04L 9/00

(52) U.S. Cl. 713/200

(57) ABSTRACT

A wireless identification lock is suitable for USB slot and must be used with security software for being used wirelessly. According to the position relations of transmitter and receiver. The security software is actuated for achieving the function of secret protection. If no receiver or transmitter is provided, the present invention can be operated correctly. It is only necessary to change the operation mode from locking mode to manual mode, then the security function can be provided and the original function is not effected. Thereby, the wireless identification lock provides an effective way for protection data which is very difficult to be detected.

### BACKGROUND OF THE INVENTION

1. Field of the Invention

The present invention relates to data protection, and particularly to a wireless identification lock which is suitable for USB slot and must be used with security software for being used wirelessly. According to the position relations of transmitter and receiver. The security software is actuated for achieving the function of secret protection. If no receiver or transmitter is provided, the present invention can still be operated correctly. It is only necessary to change the operation mode from locking mode to manual mode, then the security function can be provided and the original function is not effected. Thereby, the wireless identification lock provides an effective way for protection data which is very difficult to be detected.

2. Description of the Related Art

Referring to FIG. 1, there are two kinds of the prior art IBM compatible computers. One is used in DOS environment, no any security is provided for the condition that the user leaves from a computer temporarily. The other is in Microsoft Window environment, a simple screen protection is provided, which is simple and is constructed by combining secret codes. Moreover, most of the users do not know this application. Further the secret codes are stored in the window system. It can be reversely translated from ASCII codes. Therefore, the prior art ways can not provide an effective way for protecting the computer data so that the data in the computer can be stolen easily by burglars.

### SUMMARY OF THE INVENTION

Accordingly, the primary object of the present invention is to provide a wireless identification lock comprising a transmitter, a receiver and a security software, the transmitter and receiver being communicated wirelessly; the security software being associated with the operations of the transmitter and receiver. The transmitter is formed by an IC circuit board, and transmits signals wirelessly, a casing encloses the IC circuit board for being carried easily. The receiver is formed by an IC circuit board, and receives signals wirelessly, and a casing enclose the IC circuit board for being carried easily. The receiver is compatibly with the USB slot of a computer and is interacted with a computer. The security software provides a secret code input frame and related driving program for interacting with the receiver and transmitter.

The various objects and advantages of the present invention will be more readily understood from the following detailed description when read in conjunction with the appended drawing.

### BRIEF DESCRIPTION OF THE DRAWINGS

FIG. 1 is a schematic view showing the use of a prior art computer.

FIG. 2 is a schematic view showing one application of the present invention.

FIG. 3 is a schematic view showing one application of the present invention, where the user returns to the computer.

FIG. 4 is a schematic view showing that the user leaves from the computer.

FIG. 5 is another schematic view showing that the user leaves from the computer.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

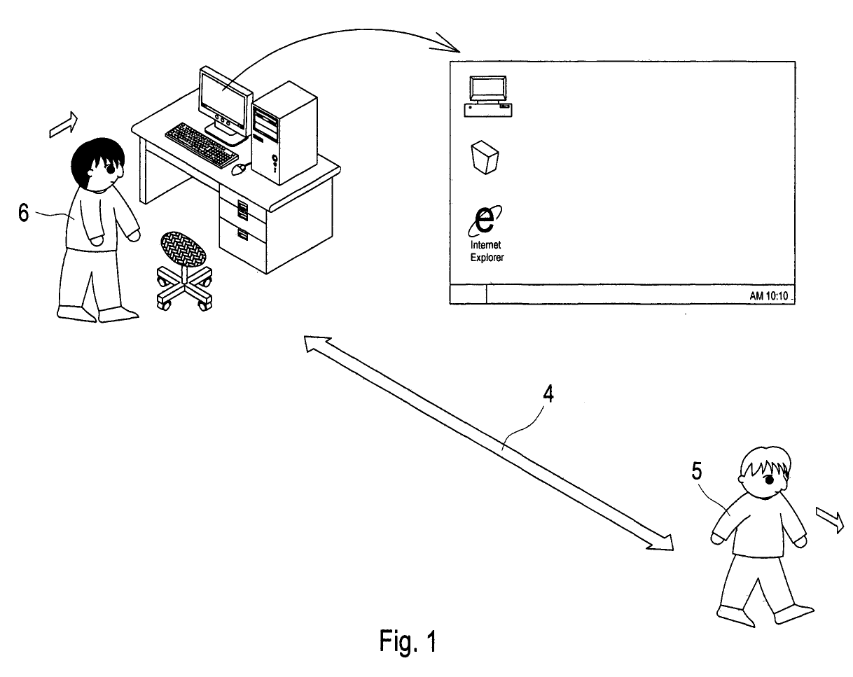

With reference to FIG. 1, in the prior art design, the burglar can steal the data in a computer without any encryption system in a very short time by reverse translating the SACII codes in the system.

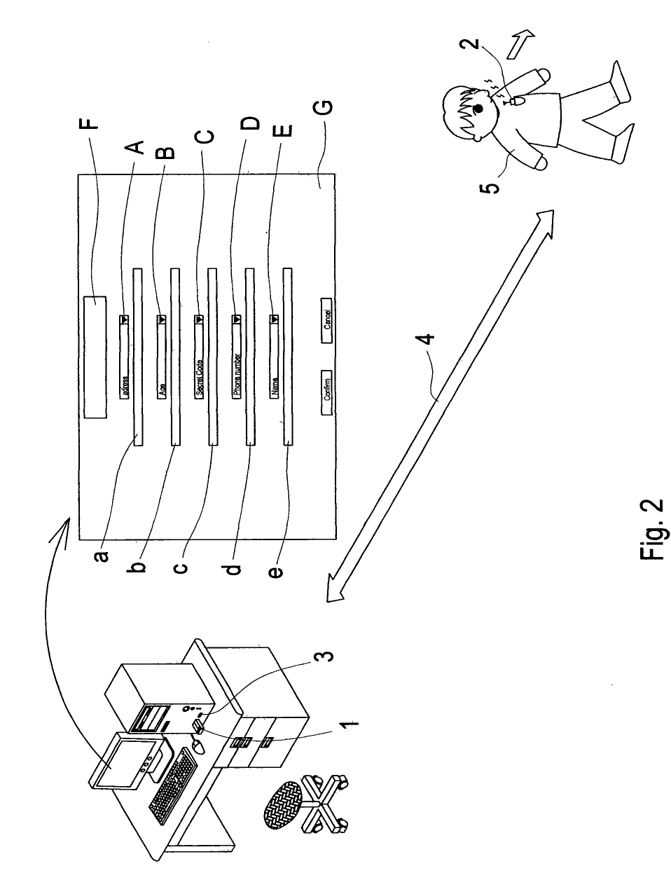

Referring to FIG. 2, the present invention is formed by a receiver 1, a transmitter 2 and software. The USB interface 3 of the receiver 1 is used for communicating with the computer. When a user installs a security software dedicated to a wireless identification lock under window environment, the install program installs the software and driver program into the window so that the receiver 1 can receive signal through the USB interface and the security software and control the actuation and de-actuation of the security software.

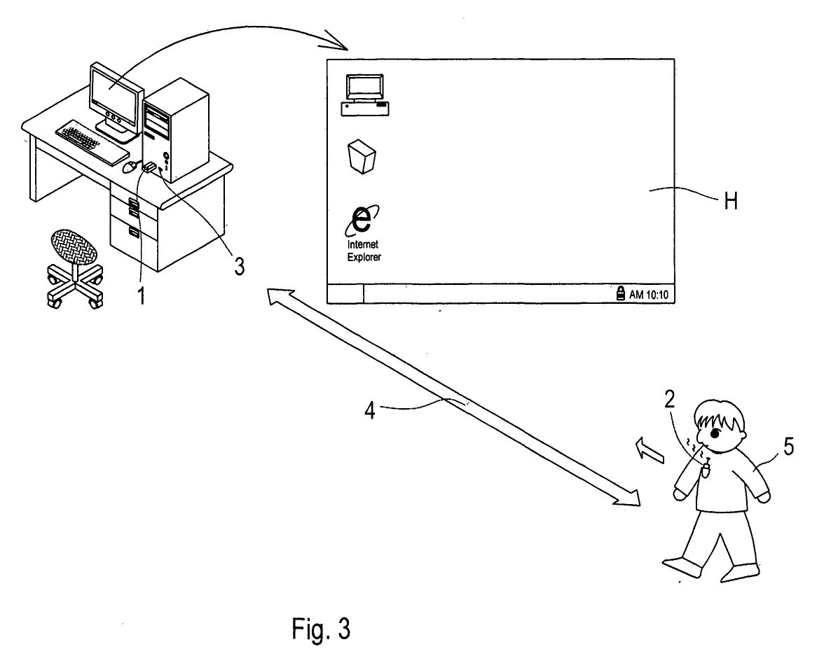

In the first embodiment of the present invention, the receiver 1 and transmitter 2 are used. The receiver 1 and transmitter 2 have same frequency and transmit acknowledge signals in a predetermined time period which can be assured by users so that the receiver 1 and transmitter 2 can communicate wirelessly. Signals are transmitted from the transmitter 2 and are received by the receiver 1. If the distance between the receiver 1 and transmitter 2 is over a predetermined value, the receiver 1 can not receive the signals from the transmitter 2. The receiver 1 will actuate the security software through the USB interface. The operation mode of the computer will be switched to lock mode from the original window mode. Then, the data in the computer is protected and thus is difficult to be stolen, as shown in FIG. 3. When the user returns to the computer, the receiver 1 receives signals from the transmitter 2. Then the receiver 1 releases the locking of the security software through the USB interface. Then the frame is switched from the locking frame G to the window frame H. When the user returns, the user can uses the computer directly so as to achieve the function of protecting secretary data.

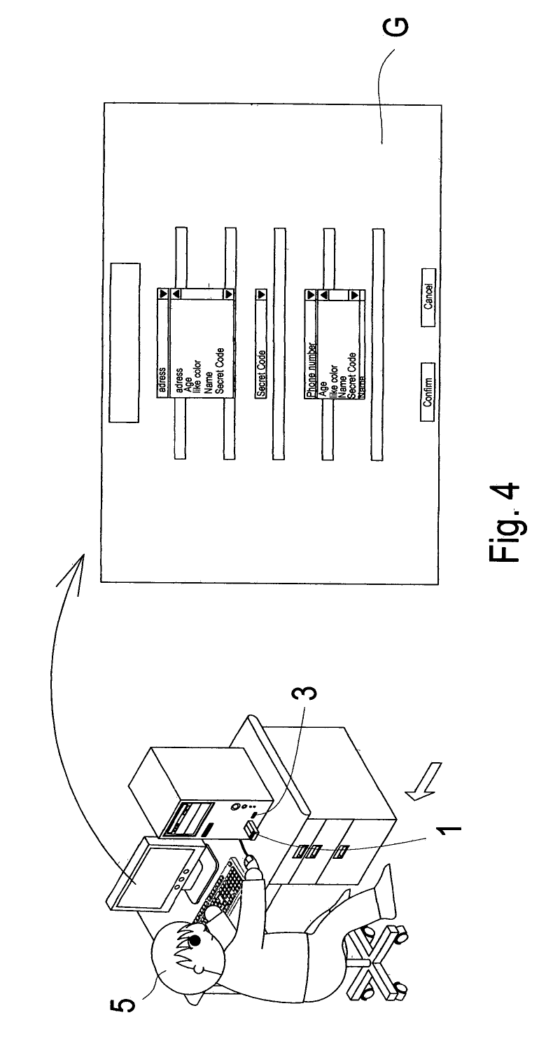

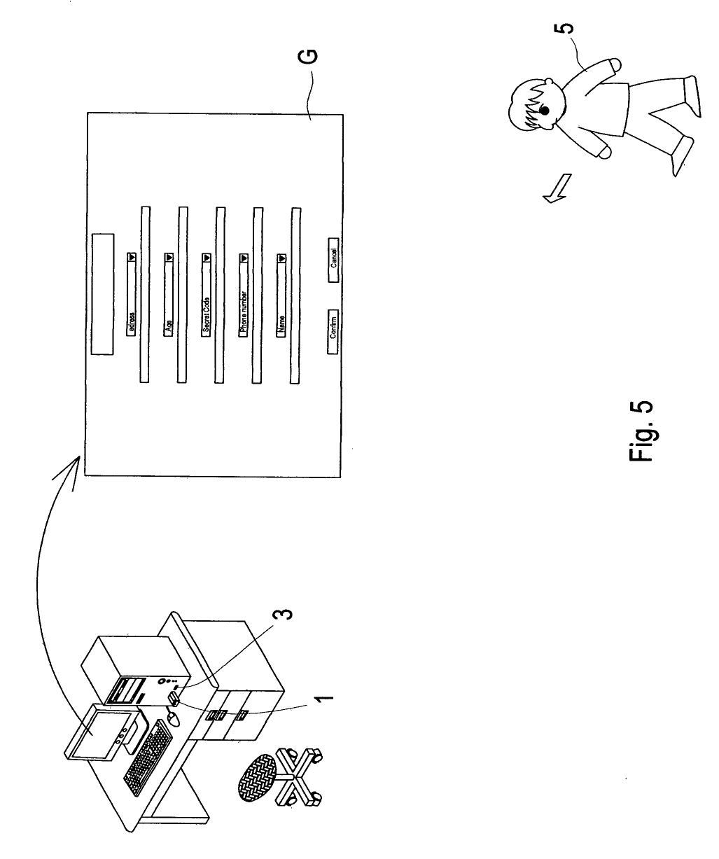

In the second embodiment of the present invention, as shown in FIGS. 3 and 4, because the carelessness of the user or other factors, one of the receiver 1 or transmitter 2 is not actuated. In this embodiment, it is retained the operation of the security software. Since one of the transmitter 2 and receiver 1 is not used, the user must click a lock icon at the right lower corner of the frame H to actuate the security software. Then a lock frame G is displayed on the computer, as shown in FIG. 5. After the user returns, the user can input secret codes so that the frame is switched from G to H. The user can use the computer continuously.

FIG. 2 shows the lock frame G of the security software. F is an alarm field to inform the burglar that the operation is illegal. The contents of the message can be determined by the user, A, B, C, D and E are data fields which can be scrolled. The field includes address field, age field, secret code field, phone number field, etc. However, other field arrangement can be used without being confined to above mentioned examples. Each field can be correspondent to secret codes a, b, c, d, and for inputting secret codes by users. Not all secret code fields or data fields are filled. It can be determined by users. Users must input correct data to the fields for using the data in the computer. The more the fields being set, the smaller the possibility that the secret codes are detected. The possibility may be as smaller as one billionth. It is impossible to detect the secret codes within several minutes.

The advantages of the present invention is that the security software can be actuated and detached automatically. The present invention is used in conditions that the user leaves from the computer for the occasion and is difficult to be resolved so that data is very difficult to be stolen. By embodiment, several secret codes can be set by the user.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A wireless identification lock comprising a transmitter, a receiver and a security software, the transmitter and receiver being communicated wirelessly; the security software being associated with the operations of the transmitter and receiver.

2. The wireless identification lock as claimed in claim 1, wherein the transmitter is formed by an IC circuit board, and transmits signals wirelessly, a casing enclose the IC circuit board for being carried easily.

3. The wireless identification lock as claimed in claim 1, wherein the receiver is formed by an IC circuit board, and receives signals wirelessly, a casing enclosing the IC circuit board for being carried easily; the receiver is compatibly with the USB slot of a computer and is interacted with a computer.

4. The Wireless identification lock as claimed in claim 1, wherein the security software provides a secret code input frame and related driving program for interacting with the receiver and transmitter.

5. The wireless identification lock as claimed in claim 1, wherein the security software provides a function of inputting secret codes, and includes five data fields and five secret codes; the five fields includes at least six selectable items, when input correct fields or secret codes disappears and a frame of the computer restores to a default frame.
